(19) United States
(12) Patent Application Publication
(10) Pub. No.: US 2024/0230603 A1
(43) Pub. Date: Jul. 11, 2024

(54) METHOD AND SYSTEM FOR CARBON ISOTOPIC RATIO ANALYSIS IN NATURAL GAS

(71) Applicant: PETRÓLEO BRASILEIRO S.A. – PETROBRAS, Rio de Janeiro (BR)

(72) Inventors: MARCELO RIBEIRO COSTA, Rio de Janeiro (BR); GABRIEL MORAES SILVA, Rio de Janeiro (BR); TULIO ALVES FREIRE, Rio de Janeiro (BR); ALEXANDRE DE ANDRADE FERREIRA, Rio de Janeiro (BR)

(73) Assignee: PETRÓLEO BRASILEIRO S.A. – PETROBRAS, Rio de Janeiro (BR)

(21) Appl. No.: 18/394,379

(22) Filed: Dec. 22, 2023

(30) Foreign Application Priority Data
Dec. 27, 2022 (BR) 1020220266859

(51) Int. Cl. G01N 30/72; B01D 53/02; G01N 30/02; G01N 30/06; G01N 31/12

(52) U.S. Cl. CPC G01N 30/7206; B01D 53/025; G01N 30/06; G01N 31/12; G01N 2030/025; G01N 2030/067

(57) ABSTRACT

The present invention describes a system and method for analyzing carbon isotope ratio in natural gas. Said system comprises a sample injection vessel (1), a chromatograph (2) comprising a first chromatographic column (3) and a second chromatographic column (5), in which a combustion reactor (4) is presented between said first and second chromatographic columns, external to the chromatograph (2), and in which an isotope ratio mass spectrometer (6) is connected to the output of the second chromatographic column (5) and feeds the data system (7) with the results found for the sample in order to generate the chromatogram.

In a second modality, the method of analyzing the carbon isotopic ratio in natural gas comprises the use of said system, which allows greater separation between the nitrous oxide and carbon dioxide components, eliminating the interferences found in the state of the art.

### FIELD OF THE INVENTION

The present invention is related to the field of material analysis methods, more specifically in the instrumental analysis of gaseous compounds originating from natural gas.

The present invention describes a method and system that provides a greater distance between the peaks generated by the natural gas samples components before passing through the isotope ratio mass spectrometer, eliminating interference between the peaks and enabling greater separation and detection.

### DESCRIPTION OF THE STATE OF THE ART

Natural gas samples collected directly in exploratory areas have a high atmospheric air content (>90% on average). High levels of air (comprising oxygen and nitrogen) cause interference in the determination of the carbon isotopic ratio of the methane molecule present in the sample, considerably increasing the uncertainty of the analytical result. This occurs because, in the gas chromatography system coupled to the isotope ratio mass spectrometer usually adopted, when leaving the combustion reactor, the sample components are carried to the spectrometer, where they are detected, generating the peaks and, finally, the result of the carbon isotopic ratio is obtained in the data system. In this original condition, the nitrous oxide peaks (N₂O), coming from atmospheric nitrogen, and the carbon dioxide (CO₂) ones, originating from methane (CH₄), are very close.

This proximity between the peaks leads to a much more imprecise isotopic ratio result for methane, which creates difficulty in interpreting geochemical data, causing the information to lose, or substantially reduce, its potential relevance.

Different methodologies can be found in the literature that address this technical problem and aim to solve it through the use of liquid nitrogen and other devices, which creates greater complexity in analytical installations and increases the risk of accidents, as discussed below.

The studies of Melton et al. (Stable carbon isotope ratio analyses on trace methane from ice samples, Chemical Geology, Volume 288, Issues 3-4, 2011, Pages 88-96, ISSN 0009-2541) present a system for measuring the concentration and stable isotope ratios of methane from air compartments in ancient ice. Particularly, Melton et al. reveal an improved method of continuous flow isotope ratio mass spectrometer (CF-IRMS) gas of microextraction chromatography for extracting and measuring the 13C/12C (δ13CH4) methane ratio from air occluded in glacial ice. The described technique uses a post-combustion liquid N₂ trap, which retains CO₂ from methane with the aim to generate a peak of greater amplitude. Thus, with elution in the second column, there is an increase in the amplitude of the methane signal and a reduction in the signal/noise ratio. After combustion and passage through liquid N₂, it is found that CO₂ from methane (CH₄) then passes to a second GC column (30 m long×0.53 mm ID GSQ Poraplot®) maintained at room temperature. It is reported that this column separates CO₂ coming from CH₄ from N₂O after passage through the post-combustion liquid nitrogen trap. Therefore, the separation that occurs in this method is the result of the second column combination with the post-combustion liquid nitrogen trap, which favors the separation of CO₂ from CH₄ and N₂O.

Although Melton et al. also use a system that comprises two chromatographic columns with a combustion reactor between them (the second column being PoraPLOT Q for separating CO₂ from CH₄ and N₂O), it is possible to note that a two-column system with a combustion reactor is not used between them, since a trap with liquid nitrogen is added after the combustion reactor and before the second column, which the author calls a post-combustion trap. Thus, Melton et al. present the use of cryogenic traps (using liquid nitrogen) to eliminate interference, while the methodology proposed in the present invention aims to avoid the use of liquid nitrogen.

The manufacturer's publication document Agilent Technologies Inc, “Agilent PoraPLOT Q Application Note”, describes the applications of the Agilent PoraPLOT Q column in the separation of six different gases in a seven-minute elution. The resulting chromatogram demonstrates that the PoraPLOT Q column is capable of eluting CO₂ e N₂O at different peaks.

However, it should be noted, that the results are related to the process conditions, which differ from those of the present invention. Among them, the detector used consists of a thermal conductivity detector (TCD), and not an isotope ratio mass spectrometer, like the present invention. Said Agilent column is limited for presenting the groups of molecules that can be separated by the column in question under a given base condition. The detail of the methodology presented in this work is not in the use of the PoraPlot Q column, or similar, essentially, but in the combination of two PoraPlot Q columns installed in specific positions in order to obtain the desired result. In other words, the central point is the form and application conditions of the column. The methodology presented by Agilent is based on a standard chromatographic system with an FID or TCD type detector. These detectors do not present difficulties to be overcome because their application is different from the isotope ratio mass spectrometry system used in the present invention. The equipment demonstrated in the publication by the manufacturer Agilent Technologies Inc still operates with a split injector injection system and does not define the origin of the sample, whereas this invention is aimed at the analysis of natural gas samples and does not use the same process conditions.

Document CN 112345667 describes a method for preparing and analyzing a carbon sample, in particular to a device and a method for preparing gaseous hydrocarbon and analyzing a carbon isotope online. According to the summary thereof, gaseous hydrocarbon preparation and on-line carbon isotope analysis device of the invention adds a liquid nitrogen cold trap in front of a gas chromatographic column to effectively extract hydrocarbon compounds in a sample.

More specifically, the invention of said Chinese application reveals a system comprising: 1, three-way valve; 2. a quartz sample tube; 3. a vaporization chamber; 4. a sample feeding cylinder; 5. a six-way valve; 6. a U-shaped enrichment pipe; 7. liquid nitrogen cold trap; 8. a gas chromatograph; 9. a combustion furnace; 10. a water removal device; 11. an isotope mass spectrometer; a. a reaction device; b. a hydrocarbon gas enrichment and separation device; c. a combustion apparatus.

Said document CN 112345667 discloses a method for analyzing carbon isotopes from gas samples in rocks using a PoraPLOT Q chromatographic column, and there is traditional use of cryogenic traps (with liquid nitrogen) to eliminate interference. The present invention, on the other hand, eliminates the use of liquid nitrogen.

Utility model CN 209927805 U refers to a device that constitutes the analysis nitrogen oxygen isotope. According to the summary thereof, device for analyzing the nitrogen-oxygen isotope composition provided by the utility model comprises a first gas purification and separation device; the gas cracking-separating and purifying device comprises a second chromatographic column, a corundum platinum tube cracking furnace and a second gas purifying and separating device which are sequentially communicated. The second chromatographic column 8 is connected to the first gas purification and separation device; and a gas isotope mass spectrometer communicating with the second gas purification and separation apparatus.

The above utility model does not fall within the same technical field as the present invention, mainly because it does not seek to separate CO₂ and N₂O gases from the analysis of the isotopic ratio of C1-C5 hydrocarbons. Furthermore, document CN 209927805 U also mentions the use of a third chromatographic column and cold traps that make use of liquid nitrogen, which, as already mentioned, are not used in the present invention.

The dissertation by Rozo Morales, Laura Juliana Implantação de método para análise de isótopos estáveis de carbono (n-alcanos C1-C5) em gases a baixas concentrações—(Implementation of a method for analyzing stable carbon isotopes (n-alkanes C1-C5) in gases at low concentrations—Dissertation (Master's)—Pontifical Catholic University of Rio de Janeiro, Department of Chemistry, 2011, aimed to develop and characterize an in-line pre-concentration and injection procedure to perform isotopic analysis (δ13C) of C1-C5 gases at low concentrations. Using standards of known isotopic composition, different preconcentration methodologies were tested and isotopic fractionation was evaluated.

The dissertation falls within the same technical field as the present invention, however, it focuses on other methodologies for isotopic ratio analysis, such as pre-concentrator devices, valve systems and chemical traps. Once again, the use of cryogenic traps that make use of liquid nitrogen is used as a device to treat interference and contamination. The present invention, on the other hand, does not use such cryogenic traps with liquid nitrogen or the like.

Therefore, no works were identified that anticipated the elution of CO₂ and N₂O gases in a second chromatographic column after passing through the combustion reactor without the aid of other methods and devices, in accordance with the present invention.

Therefore, no prior art document discloses a system and method for analyzing carbon isotope ratio in natural gas like that of the present invention. Likewise, the combination of prior art documents would not render the solution of the present invention obvious or deducible, since it would not motivate a person skilled in the art to discard auxiliary methodologies in order to obtain adequate separation results.

Therefore, it is indisputable the need to develop technologies capable of allowing the separation of CO₂ and N₂O peaks through a simple, safe and low-cost system.

### BRIEF DESCRIPTION OF THE INVENTION

Initially, it is worth highlighting that the following description starts from the preferred embodiments of the invention, without being limited by them.

The present invention describes a system and method for analyzing carbon isotope ratio in natural gas. Said system comprises a sample injection vessel (1), a gas chromatograph (2) comprising a first chromatographic column (3) and a second chromatographic column (5), in which a combustion reactor (4) is presented between said first and second chromatographic columns, external to the chromatograph (2), and in which an isotope ratio mass spectrometer (6) is connected to the output of the second chromatographic column (5) and feeds the data system (7) with the results found for the sample in order to generate the chromatogram.

The sample injection system is manually by syringe, and an autosampler system can be used with trays compatible with the sampling vial used.

According to the system of the present invention, the first and second chromatographic columns (2, 5) can be selected from PoraPLOT Q, HP-PLOT Q, PoraPLOT Q, Rt-Q Bond, Supel Q PLOT and AT-Q.

In a second embodiment, the present invention describes the method of analyzing the carbon isotope ratio in natural gas, which comprises the following steps:
(a) opening the carrier gases, preferably using helium gas;
(b) adjusting the process conditions of the system as defined in the present invention;
(c) inserting 10 uL to 200 uL of natural gas sample with a split ratio of 50:1 to 10:1 into the sample vessel (1) of the system defined in the present invention;
(d) activating the system; and
(e) collecting the resulting data.

### BRIEF DESCRIPTION OF THE FIGURES

To assist in identifying the main characteristics of the present invention and its results and technical purposes, the figures to which reference is made are presented, as follows:

FIG. 1 shows the modified system of the present invention, in which (1) depicts the sample injection container, (2) depicts the gas chromatograph, (3) depicts the first chromatographic column, (4) depicts the combustion reactor, (5) depicts the second chromatographic column, (6) depicts the isotope ratio mass spectrometer, and (7) depicts the data system for processing.

FIG. 2 shows the chromatogram resulting from an original system, in which there is no second chromatographic column after the eluent passes through the combustion reactor. As can be seen, the air peak (first peak) interferes with the CO₂ peak (160.93) from methane.

FIG. 3 shows the resulting chromatogram of the system as defined in the present invention, in which the second chromatographic column makes it possible to separate the components and eliminate the interference of the air peak (first peak) with the CO₂ peak from methane (238.68).

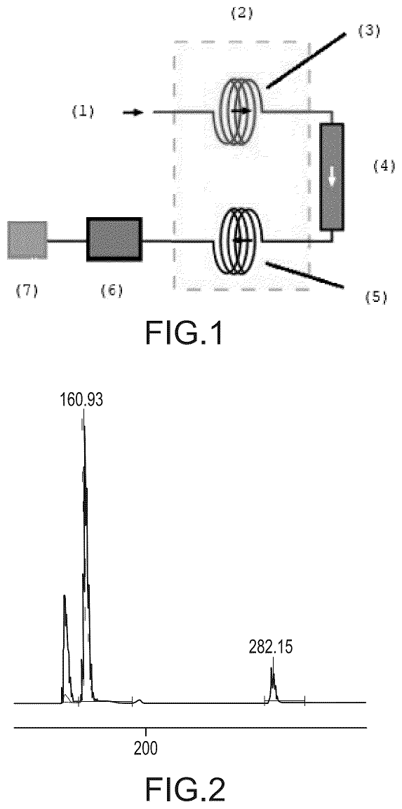

### DETAILED DESCRIPTION OF THE INVENTION

The present invention describes a system and method for detecting the signal generated by the drilling gas samples components, which have in their composition, the components: Methane (C1), Ethane (C2), Propane (C3), Butanes (C4), Pentanes (C5), Carbon Dioxide (CO₂) and atmospheric air (comprising oxygen and nitrogen). Such samples represent a large portion of the demand for this analytical technique, but they have very high levels of atmospheric air (in general, above 90% by volume).

Given this scenario, current methods and systems are not capable of satisfactorily distinguishing nitrous oxide (N₂O) and carbon dioxide (CO₂) peaks from methane (C1), causing distortion in the result of the isotopic ratio of carbon from methane (C1) since they are too close.

The system proposed in the present invention comprises a sample injection vessel (1), a gas chromatograph (2) comprising a first chromatographic column (3) and a second chromatographic column (5), in which a combustion reactor (4) is presented between said first and second chromatographic columns, external to the gas chromatograph (2), and in which an isotope ratio mass spectrometer (6) is connected to the output of the second chromatographic column (5) and feeds the data system (7) with the results found for the sample in order to generate the chromatogram.

According to the system of the present invention, the first and second chromatographic columns (2, 5) can be selected from HP-PLOT Q, PoraPLOT Q, Rt-Q Bond, Supel Q PLOT and AT-Q.

The column preferably used in the present invention is the PoraPLOT Q, which has the following parameters: length of 10 m, internal diameter of 0.32 mm, film thickness of 10.00 μm and temperature range of −100 to 250/250° C., having 2 particle traps integrated at the beginning and end of the column with 2.5 m each.

The gas sample is injected (1) into the gas chromatograph (2), passing through the first chromatographic column (3), where the atmospheric air, hydrocarbons (C1 to C5) and carbon dioxide are separated, however, air and methane do not present satisfactory separation. Then, the components of the first chromatographic separation pass through the combustion reactor (4), where the hydrocarbons are oxidized to carbon dioxide, and the nitrogen in the air is oxidized to nitrous oxide. After combustion, the sample components elute through the second chromatographic column (5), where the nitrous oxide arising from the oxidation of atmospheric nitrogen and the carbon dioxide originating from the oxidation of methane are separated more efficiently and elute to the isotope ratio mass spectrometer (6), where the signal relative to each component is detected.

It was observed by the inventors that a second chromatographic column (5) after the combustion reactor (4) allows a second, more efficient separation process between the sample components.

The system of the present invention allows all hydrocarbons to be converted to carbon dioxide (CO₂) by passing through the combustion reactor (4), so that only the N₂O molecule and CO₂ molecules are present in the following sequence: N₂O, CO₂ originating from methane, CO₂, CO₂ originating from ethanes, CO₂ originating from propanes, CO₂ originating from butanes and CO₂ originating from pentanes. Since CO₂ molecules have the same interaction with the chromatographic column (5), the relative distance between the CO₂ peaks does not change, however, the interaction difference with the second chromatographic column (5) between N₂O e CO₂ molecules originating from methane is greater than the interaction difference between N₂O and Methane (C1). After the second chromatographic in separation the second chromatographic column (5), the components are then carried to the isotope ratio mass spectrometer (6), where they are detected, generating the peaks of each component. Finally, the result of the carbon isotopic ratio for each component of the sample (1) is obtained in data processing in the data system (7).

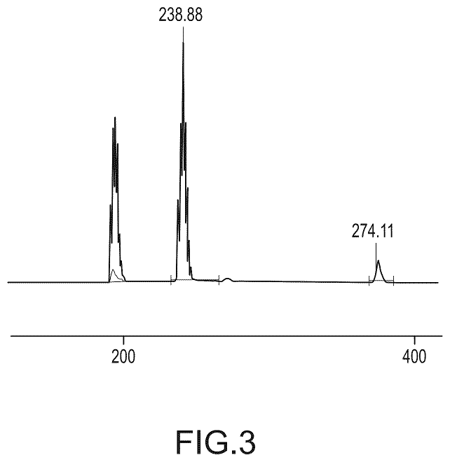

The presence of the second chromatographic column (5) provides a greater distance between the N₂O and CO₂ peaks originating from methane at the outlet, eliminating the interference that originally existed, as shown in FIG. 2, and enabling greater separation between the N₂O and CO₂, as shown in FIG. 3.

Because there is no longer interference from the N₂O peak at the CO₂ peak originating from methane, the result of the isotopic ratio for methane (C1) gains greater accuracy, precision and relevance.

A second embodiment of the present invention refers to the method of analyzing the carbon isotope ratio in natural gas, which comprises the following steps:
(a) opening the carrier gases, preferably Helium 5.0 (99.999% purity);
(b) adjusting the system process conditions, so that the carrier gas flow is adjusted between the range of 1.5 mL/min and 2.5 mL/min, preferably, 1.7 mL/min; the temperature of the combustion reactor is adjusted between 950° ° C. and 1050° C., preferably, 1000° C. and the temperature conditions of the columns, normally both maintained at the same final temperature, are adjusted according to the following schedule: 4 min at 40° C., heating to 240° C. at a rate of 10° C./min, being maintained at 240° ° C. for 1.5 min; or any values between 2 min to 6 min, heating in the range of 200° ° C. to 240° C., heating rate in the range of 8° C./min to 12° C./min, finally maintained at the final temperature for 1 min to 5 min.
(c) inserting 10 uL to 200 uL of natural gas sample with a split ratio of 50:1 to 10:1; in the sample vessel (1) of the system;
(d) activating the system; and
(e) collecting the resulting data.

The process conditions of step (b) refer to the temperature of the columns, which are adjusted according to the following schedule: 4 min at 40° ° C., heating to 240° C. at a rate of 10° C./min, maintains at 240° ° C. for 1.5 min. Under the adopted process conditions, it was noted that the difference between the retention times (time elapsed, in seconds, between the beginning of the analysis and the peak apex of a sample component) of the atmospheric air and methane peaks increased approximately 4 times, eliminating interference from atmospheric air on the methane signal, as can be seen in FIGS. 2 and 3.

The system and method proposed by the present invention differ from the prior art, which employ solutions using liquid nitrogen, and present a reduction in analytical cost and a simplification of the structure necessary for implementation. With the elimination of this interference, the reliability of the analytical data associated with this compound increases, enough for them to be considered in the geochemical interpretation process.

Those skilled in the art will value the knowledge presented herein and will be able to reproduce the invention in the presented embodiments and in other variants, covered in the scope of the appended claims.

1. System for carbon isotopic ratio analysis in natural gas characterized by comprising:
a sample injection vessel, a gas chromatograph comprising a first chromatographic column and a second chromatographic column, in which a combustion reactor is presented between said first and second chromatographic columns, externally to the gas chromatograph, and
wherein an isotope ratio mass spectrometer is connected to the output of the second chromatographic column and feeds the data system with the isotopic ratio results.

2. System, according to claim 1, characterized in that the first and second chromatographic columns can be selected from HP-PLOT Q, PoraPLOT Q, Rt-Q Bond, Supel Q PLOT and AT-Q.

3. System, according to claim 1, characterized in that the first and second chromatographic columns are preferably selected from PoraPLOT Q.

4. Method for carbon isotopic ratio analysis in natural gas, characterized in that it comprises the following steps:
(a) opening the carrier gases;
(b) adjusting the process conditions of the system as defined in claim 1;
(c) inserting the natural gas sample into the sample container (1) of said system;
(d) activating said system; and
(e) collecting the resulting data.

5. Method, according to claim 4, characterized in that the carrier gas is helium 5.0 gas with 99.999% purity.

6. Method, according to claim 4, characterized in that the natural gas sample of 10 uL to 200 uL with split ratio of 50:1 to 10:1 is injected into the sample container.

7. Method, according to claim 4, characterized in that the carrier gas flow (helium 5.0) is preferably set at 1.7 mL/min, but can be adjusted in the range between 1.5 mL/min and 2.5 mL/min.

8. Method, according to claim 4, characterized in that the process conditions has as a characteristic the temperature of the combustion reactor preferably reaching between 950° C. and 1050° C., but preferably a temperature of 1000° C.; and the temperature conditions of the columns maintained the same and adjusted according to the following schedule:
between 2 min to 6 min, heating temperature in the range of 200° ° C. to 240° C., heating rate in the range of 8° C./min to 12° C./min and maintained at the final temperature for 1 min to 5 min.

9. Method, according to claim 8, characterized in that the conditions in the column, preferably follow the following schedule: 4 min at 40° ° C., heating to 240° C. at a rate of 10° C./min, being maintained at 240° C. for 1.5 min.
